(19) United States
(12) Patent Application Publication
(10) Pub. No.: US 2005/0087521 A1
(43) Pub. Date: Apr. 28, 2005

(54) Method of making patterns for decorative piece

(76) Inventor: Shih-Sheng Yang, Taipei Hsien (TW)

Correspondence Address: Shih-Sheng YANG, PO Box 82-144, Taipei, TW

(21) Appl. No.: 10/948,167

(22) Filed: Sep. 24, 2004

(30) Foreign Application Priority Data
Oct. 28, 2003 (TW) 92129968

(51) Int. Cl. B23K 26/36

(52) U.S. Cl. 219/121.69

(57) ABSTRACT

A method of making patterns for decorative piece, comprising the steps of using a metal plate as the molding substrate for laser etching, placing the mold substrate under a laser etching device for being cut by a laser beam, grooving repeatedly and radiately on a certain position level by level via different emitting diameters to form a recession with a first depth, thereafter repeating the afore-mentioned processing after removing the laser head (including the prism set) a distance, accomplishing pluralities of mold grooves averagely distributed on a surface of the mold substrate, and proceeding with plastic injection and forming tiny pins on the plastic decorative piece.

### BACKGROUND OF THE INVENTION

(a) Technical Field of the Invention

The present invention relates to a method of making patterns for decorative piece, particularly to a method of laser cutting on a metal mold for producing tiny recessions and processing plastic injection after closing the molds, thereby integrally forming on the surface of the plastic material pluralities of tiny conical pins with a tip having a diameter of only 0.07˜0.15 mm, a bottom having a diameter of only 0.35˜0.6 mm, and a height of around 0.5˜1 mm. The decorative piece of plastic, when applied to a zipper tab, may have a soft and gentle touch feeling like fluff, as well as an exquisite appearance.

(b) Description of the Prior Art

The conventional decorative piece for a zipper tab generally adopts plastic injection process to integrally form various patterns and styles, or pressing on metallic laminates to brand the desired patterns or designs. However, no matter whether the decorative piece of a zipper tab is formed by plastic injection or pressing on a metal material, the designs or patterns produced generally have a big size, without delicate styling. Also, as the material utilized is hard and rough, the feeling is cold and blunt to the touch, instead of being warm and soft.

In view of the above, the inventor of the present invention has designed a method of making pattern for a decorative piece, which can efficiently form tiny pins on soft plastic materials, which has a tip diameter of only 0.07 mm, a bottom diameter of only 0.35 mm and a height around 0.5 mm, visible as fluff, and is very soft and tender to the touch. When being applied to a pendent as a zipper element, the decorative piece has an aesthetically pleasing appearance, and a soft feeling when being touched by the fingers.

As disclosed in the inventor's U.S. patent application. Ser. No. 10/179,185 entitled “Method of making pattern for decorative piece”, tiny pins can be made accordingly. However, in the laser technology applied thereto, the path of the laser beam must be radiated from the first point, the second point, the third point, etc. to the countless point, such that a conical groove can be etched progressively. Subsequently, by way of lifting the height of the laser head to allow expansion of the radiating diameter of the laser beam, the afore-said step is processed repeatedly, while the height of the laser head is lifted time by time to expand the radiating diameter for etching the metal mold, thereby forming a conical recession.

Considering the aforementioned prior art might not be necessarily perfect, i.e. the sequent displacements of the laser head (cutter) might increase the manufacturing cost since it is not so time efficient given the time consuming displacements would not allow the manufacture capability to be developed completely.

### SUMMARY OF THE INVENTION

The primary objective of the present invention is to provide a method of making patterns for a decorative piece, which can produce on a plastic material a pattern formed by tiny pins with an integral process of time efficiency and great manufacture capability.

The secondary object of the invention is to provide a method of making patterns for a decorative piece, which can produce a pattern formed by tiny pins having a tip diameter of only 0.07 mm, a bottom diameter of only 0.35 mm and a height around 0.5 mm.

To accomplish the above objects, the method of making a pattern for a decorative piece according to the invention has the steps of using a metal plate as the substrate, etching by laser beam to form a tiny conical recession of desired depth, repeatedly and radiately grooving on the same position level by level to form a conical groove of a first depth, repeating the afore-mentioned step after removing the direction of the laser beam to a pre-determined position to form a conical groove of a second depth, repeating the above steps until accomplishing pluralities of mold grooves averagely distributed in very small distance on a surface of the mold substrate; and proceeding with plastic injection to form tiny pins on the plastic material, which is elastic in nature and is soft and tender to the touch.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1A, 1B and 1C schematically show the manufacturing procedures according to the present invention.

FIGS. 2A, 2B and 2C show forming the decorative piece of the invention via plastic injection.

FIGS. 3A, 3B, 3C and 3D show processing steps of a preferred embodiment according to the invention.

FIG. 4 shows the molds used for forming the decorative piece by way of plastic injection.

FIG. 5 is a perspective view of the completed decorative piece according to the present invention.

FIG. 6 is a partially enlarged view taken from part A in FIG. 4.

FIG. 7 is a partially enlarged view of the present invention.

FIG. 8 is partially enlarged view of another embodiment of the present invention.

FIGS. 9A and 9B are cut-away views of the laser beams according to the present invention, with the diameter of the laser beam adjusted.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

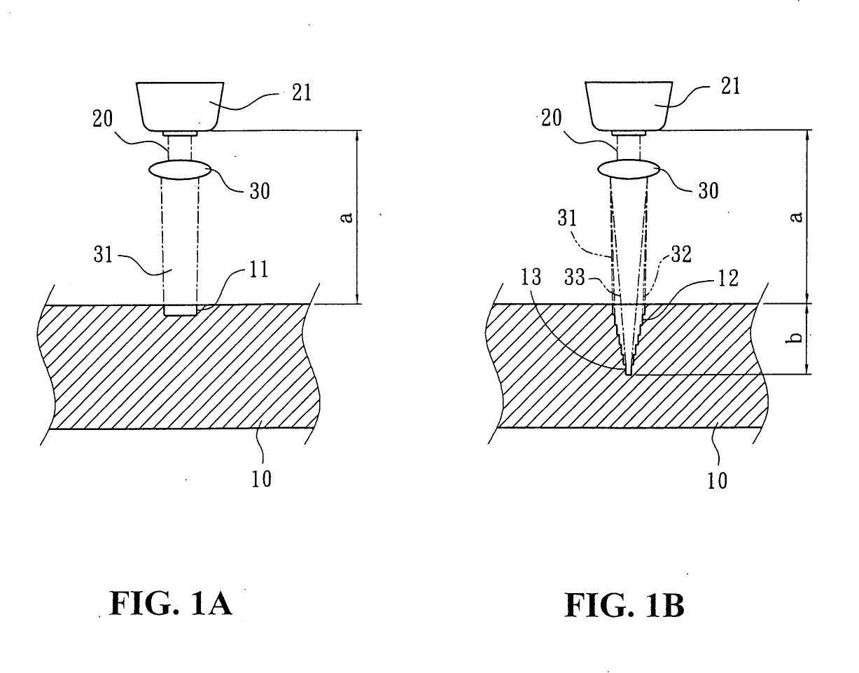

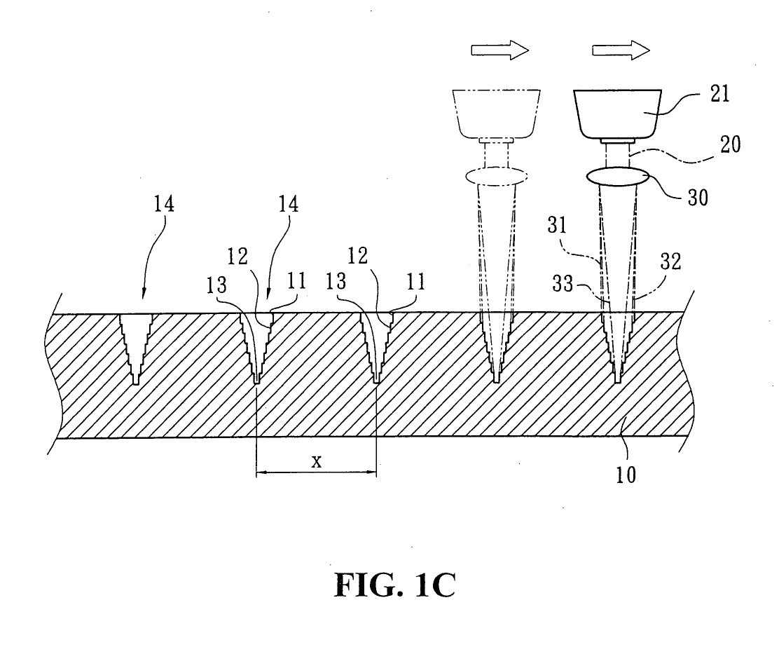

FIGS. 1A, 1B and 1C show a preferred embodiment of the present invention, wherein a mold substrate 10 is cut by a laser beam 20. The laser head 21 is distanced a height a from the mold substrate 10. A prism set 30 is disposed beneath the laser head 21, such that the laser beam 20, through the reflection of the prism set 30, can form a laser beam 31 for use in etching a groove 11 on the mold substrate 10 (as shown in FIG. 1A).

After completing the groove 11 on the mold substrate 10 as mentioned above, applying a laser beam 32 with the laser head 21 kept the same height a from the mold substrate 10 for cutting, while the laser beam 32 passes through the prism set 30 of an adjusted angle, generating a focus function, such that the laser beam 32 would have a radiating diameter smaller than that of the prior laser beam 31. As shown in FIG. 8A, the radiating range of the laser beam 31a is a circle established by an instant scanning path c of pluralities of laser scanning beams 31a. As shown in FIG. 8B, the reduced radiating range of the laser beam 32 is a circle established by an instant scanning path d of pluralities of laser scanning beams 31a through the prism set 30 of an adjusted angle, such that the radiating diameter of the focused laser beam 32 is smaller than that of the prior laser beam 31. Therefore, under the circumstance that when etching a groove 12 of another depth (as shown in FIG. 1B) on the mold substrate 10 by the laser beam 32 based on the level which is the bottom of the groove 11 generated in last processing, and that, in an applicable embodiment, the mold substrate 10 is made of steel, sequentially and repeatedly grooving for over ten times on the same position level by level to form a conical groove by laser beams with a radiating diameter of 0.38 mm, 0.30 mm, 0.23 mm, 0.16 mm and 0.08 mm, respectively, the final laser beam 33 can etch a bottom groove 13 of an appropriate depth, thereby completing a single mold groove 13, the bottom groove 13 is under the surface of the mold substrate 10 for a depth b (as shown in FIG. 1B). In the event that the mold substrate is made of aluminum or copper, the number of times for applying the laser beam radiating can be reduced. As the period of time every laser beam applies is very short, it takes quite short a span to apply over ten times repeated cutting.

According to the illustrations FIGS. 1A and 1B and the above detailed descriptions therefore, one can clearly learn that a single mold groove 14 (as shown in FIG. 1C) can be formed by sequentially grooving on the same position level by level. To form pluralities of tiny mold grooves 14 distributed on a surface of the mold substrate, the laser head 21 (including the prism set 30) can be removed after accomplishing the first mold groove 14 to repeat the aforesaid process as shown in FIGS. 1B and 1B. Depending on the surface of the material to be processed, the laser head 21 (including the prism set 30) can be moved laterally a distance x for each displacement, thereby pluralities of mold grooves 14 averagely distributed on a surface can be accomplished (as shown in FIG. 1C).

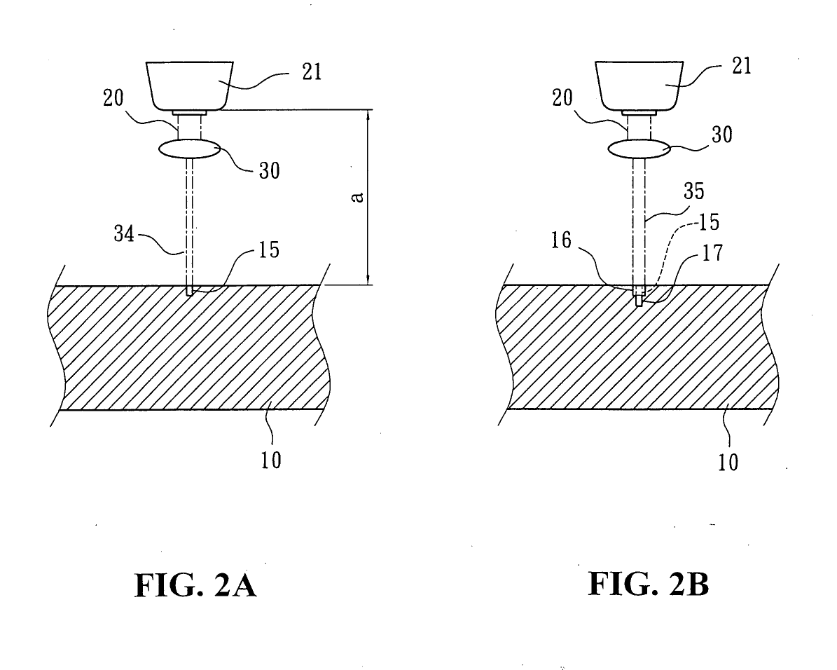

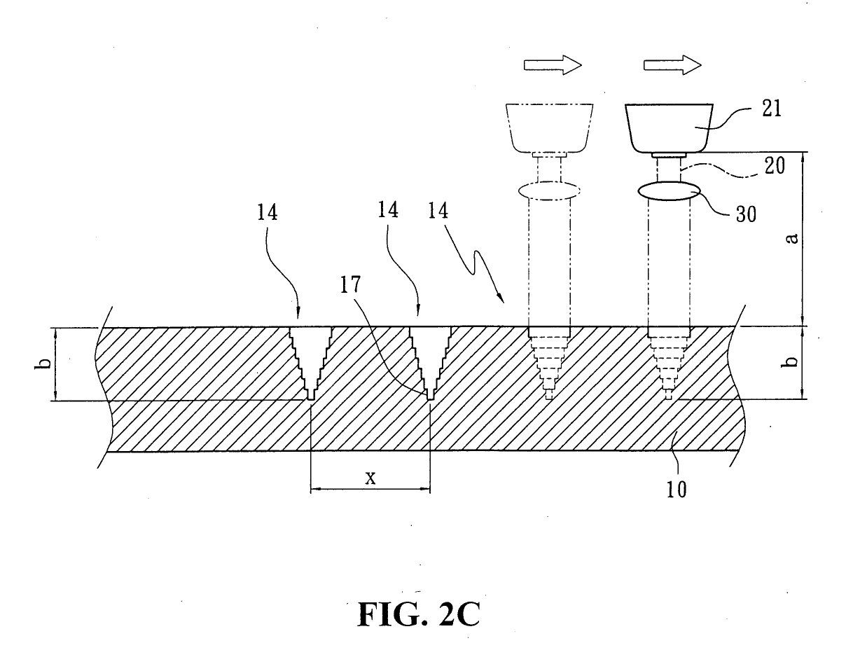

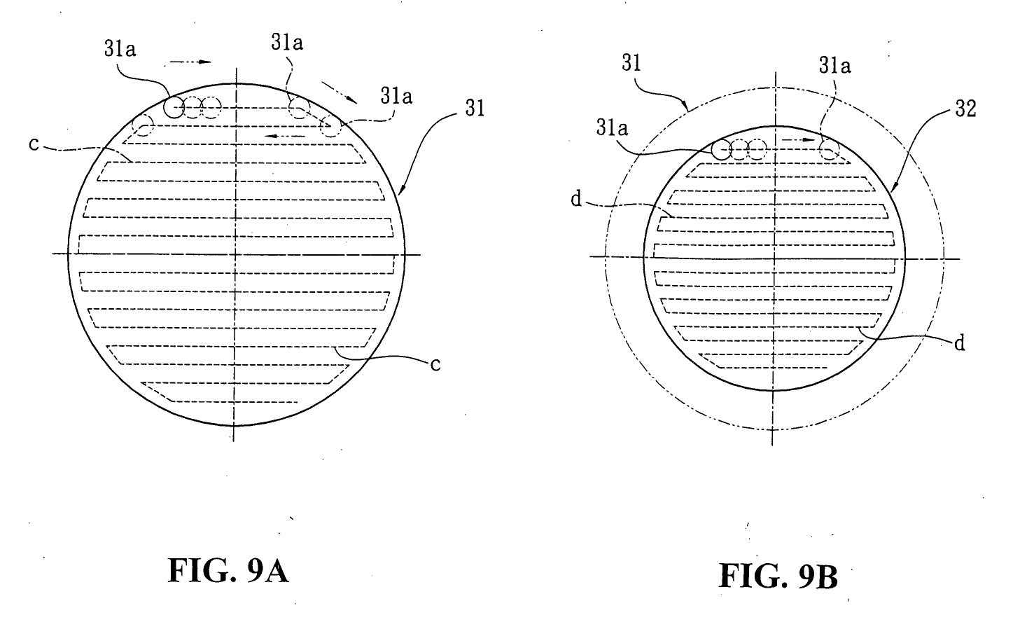

Referring to FIGS. 2A, 2B and 2C, these show the preparation of mold grooves 14 are prepared on the mold substrate 10 of another embodiment of the invention via cutting the substrate 10 by a laser beam 20. The laser head 21 is kept a distance a from the mold substrate 10, while a prism set 30 is provided beneath the laser head 21, such that the laser beam 20 will transform a laser beam 34 through the prism set with an adjusted angle. By way of the cutting by the laser beam 34 on the mold substrate 10, a narrow tiny groove 15 (as shown in FIG. 2B). Subsequently, as shown in FIGS. 9A and 9B, the diameter of the laser beam 34 is expanded to present a laser beam 35, both of which have the same center of circle. A recessive groove 16 is formed by cutting the mold substrate 10 via the laser beam 35. As the laser beam 35 is cutting over the narrow groove 15 previously formed, the bottom of said groove 15 will be further processed and formed a deeper tiny groove 17. Accordingly, the mold surface was cut by the laser beam 34 of a smaller 5 diameter, and then cut by the laser beam 35 of a larger diameter. The diameter of the laser beam is gradually enlarged and finally cut a groove of standard size on the mold substrate, thereby accomplishing the process of cutting mold grooves 14 level by level.

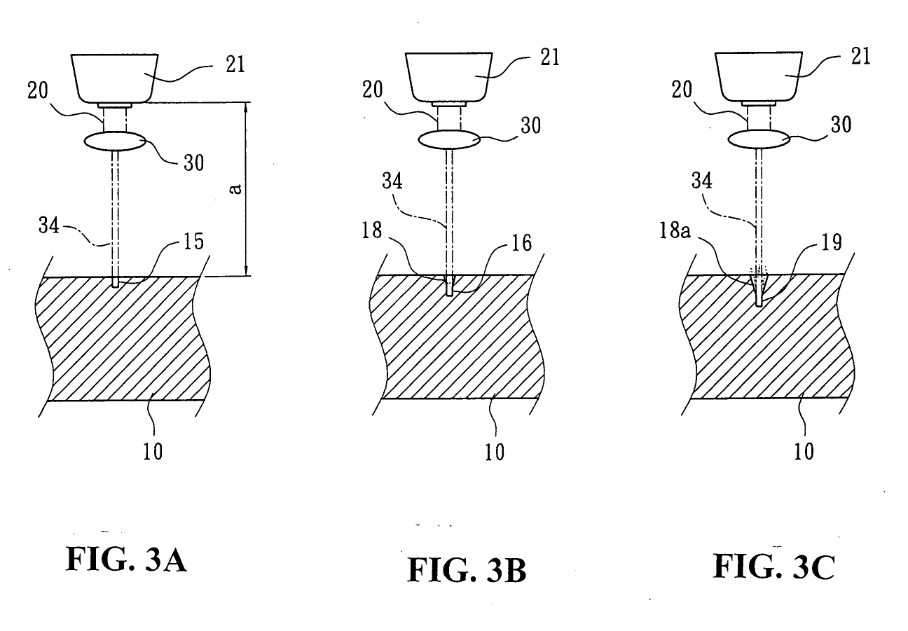

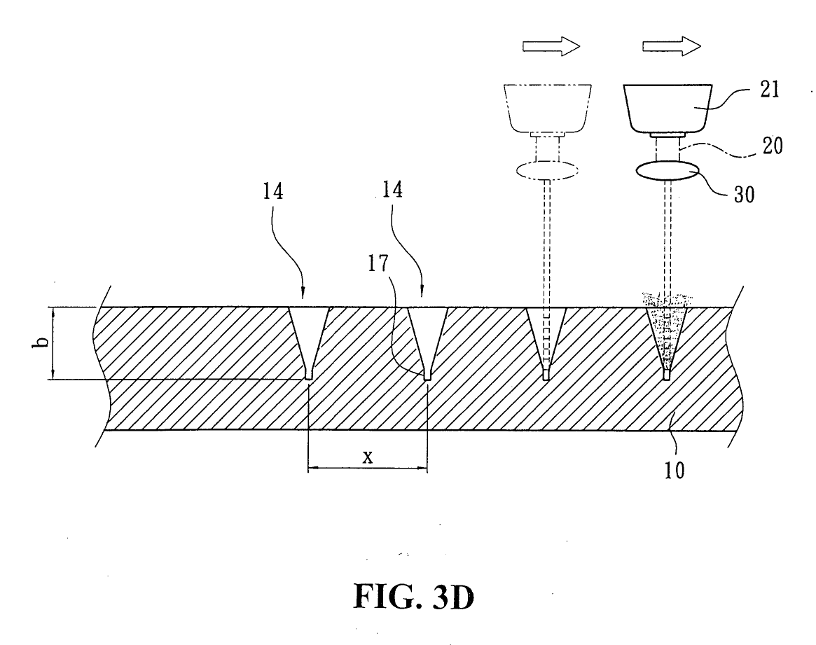

FIGS. 3A and 3B, show a preferred embodiment of the invention which is similar to that shown in FIGS. 2A and 2B. The difference is that in preparing the mold grooves 14 on the mold substrate 10, the laser beam 34 is cutting on the mold substrate 10 such that a narrow groove 15 (as shown in FIG. 3B) will form. Subsequently, the laser beam 34 is cutting on the same position on the tiny groove 15 with a lasting laser beam 34 to form a deeper groove 16 and form an inclined plane 18 (as shown in FIG. 3B) around the tiny groove 15. The groove would become a deeper groove 19 and the periphery forms a wider inclined plane 18a (as shown in FIG. 3C). According to the same processing theory, a mold groove 14 (as shown in FIG. 3D) will be formed by lastingly grooving on the same position level by level. Subsequently, the laser head 21 (including the prism set 30) a distance x laterally after a mold groove is completed, and then repeatedly processing the previous steps to finally accomplish pluralities of mold grooves 14 averagely distributed on a surface of the mold substrate 10.

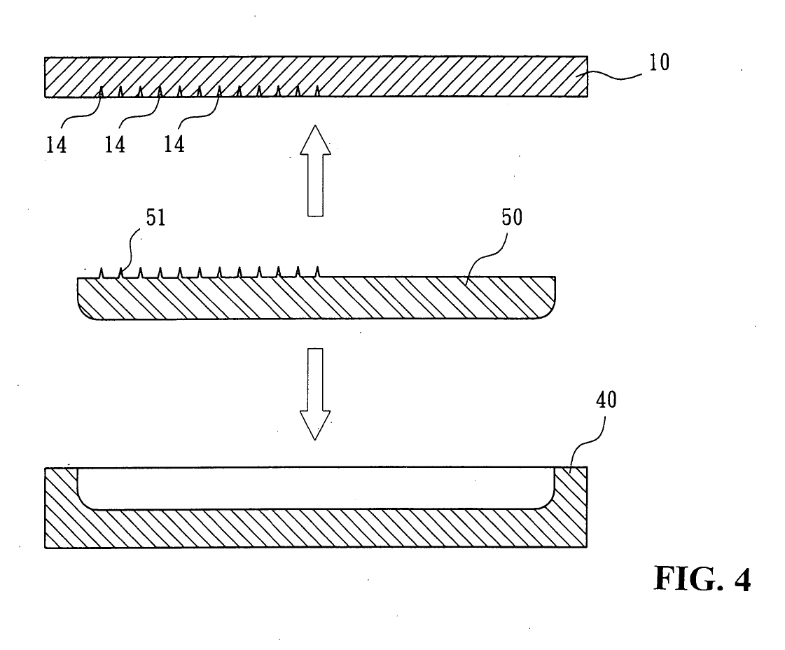

Referring to FIG. 4, after accomplishing pluralities of mold grooves 14 averagely distributed on the surface of the mold substrate 10, the mold substrate 10 being the upper mold can be closed with the lower mold 40 for processing plastic injection to form tiny pins 51 on a decorative piece 50. In a preferred embodiment, pluralities of tiny pins are integrally formed on a surface of a plastic material. Each tiny pin has a tip diameter of 0.06˜0.08 mm, a bottom diameter of 0.38˜0.6 mm, and a height of 0.4˜1 mm. The entire decorative piece made of plastic materials is quite elastic such that when being touched or squeezed, the touch and rub feeling is very soft and tender.

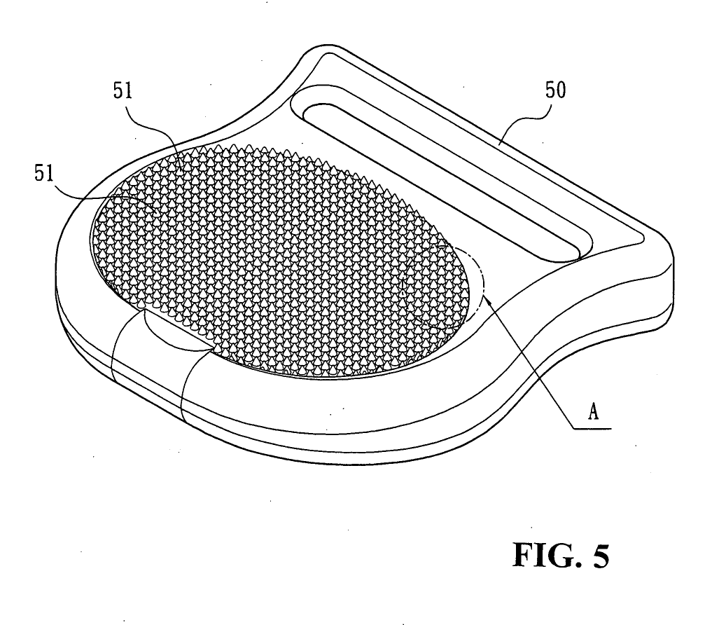

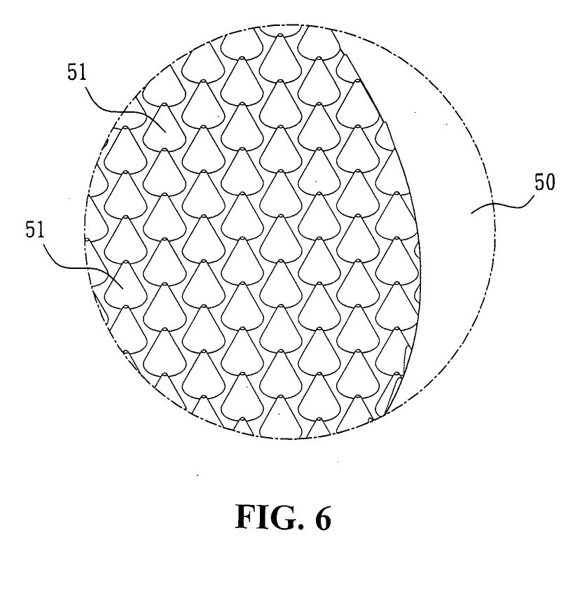

Referring to FIGS. 5 and 6, in an applicable embodiment of the invention, the decorative piece 50 may be provided with a press surface, on which pluralities of tiny pins 51 are formed, so as to obtain a extremely comfort touch feeling.

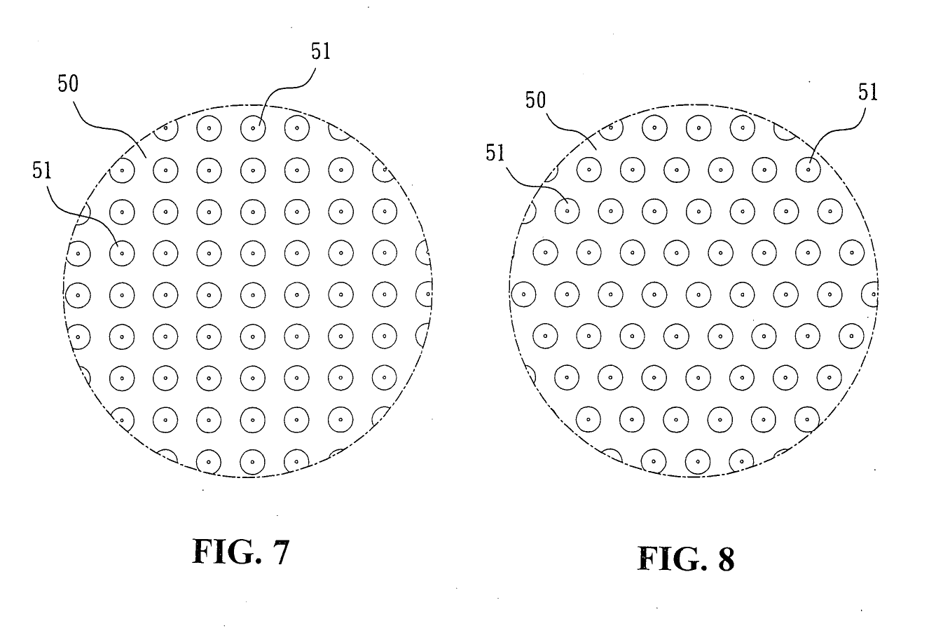

As shown in FIG. 7, there are pluralities of tine pins 51 formed on the decorative piece 50 made according to the invention. The position of the laser head 21 can be adjusted on purpose such that the processed mold grooves 14 can be arranged in a row vertically and laterally, thereby the tiny pins 51 formed on the decorative piece 50 by way of plastic injection can have an arrangement as shown in the figure.

As shown in FIG. 8, the mold grooves 14 can be arranged in an interlaced way such that the tiny pins 51 formed on the decorative piece 50 by way of plastic injection can has an arrangement as shown in the figure. Accordingly, the method of making patterns on a decorative piece according to the present invention utilize a metal plate as a mold substrate and comprising the following steps:
a. Placing a metal mold substrate under a laser cutting device;
b. Providing a prism set under the laser head which keeps a certain distance away from the mold substrate, such that the laser beam can be utilized in processing through the refraction of the prisms, thereby the processing laser beam can proceed with cutting and forming a groove on the mold substrate;
c. retaining the height of the laser head unchanged and cutting on the same position via a leaser beam, adjusting the angle of the prism set to generate a focus function on the laser beam, such that the laser beam would have a radiating diameter smaller than that of the prior laser beam, repeatedly and radiately grooving on the same position level by level to form a conical groove and complete a mold groove;
d. Moving the laser head (including the prism set) a distance laterally after the first mold groove is completed, repeatedly processing steps B to C, thereby accomplishing pluralities of mold grooves averagely distributed on a surface of the mold substrate; and
e. Proceeding with plastic injection and forming on the plastic material tiny pins which are very elastic and give a soft and tender touch feeling to the decorative piece when it is touched or squeezed.

Concluded above, the present invention produces fine conical pins to give a very soft and comfortable touch feeling and innovative artistic sense. Compared with the plastic injection manufacturing method for conventional decorative pieces, the present invention increases value and distinctive texture to the whole. In addition, a trademark logo can be further formed on the decorative piece particularly for promotion of products like garments, backpacks, and shoes, etc. The present invention complies with the patentability, and hence submitted to the Patent and Trademark Office for review and grant of the commensurate patent rights.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A method of making patterns for a decorative piece, including the following steps:
placing a metal mold substrate under a laser cutting device;
providing a prism set under the laser head which keeps a certain distance away from the mold substrate, such that the laser beam can be utilized in processing through the refraction of the prisms, thereby the processing laser beam can proceed with cutting and forming a groove on the mold substrate;
retaining the height of the laser head unchanged and cutting via a leaser beam having a different diameter from that of the prior laser beam, repeatedly and radiately grooving on the same position level by level to form a conical groove and complete a mold groove;
moving the laser head (including the prism set) a distance laterally after the first mold groove is completed, and then repeatedly processing steps B to C to accomplish the second mold groove, thereby accomplishing pluralities of mold grooves averagely distributed on a surface of the mold substrate; and
proceeding with plastic injection and forming tiny pins on the plastic material.

2. The method of making patterns for a decorative piece according to claim 1, wherein the repeatedly and radiately grooving level by level to form a conical groove mentioned in step C refers to etching on the mold substrate with the laser beam radiated through the reflection of the adjusted prism set, keeping the height of the laser head unchanged, such that the laser beam will focus and generate a processing laser beam (32), which has a radiating diameter smaller than that of the prior processing laser beam (31) used in the prior step.

3. The method of making patterns for a decorative piece according to claim 2, wherein the repeatedly and radiately grooving level by level to form a conical groove mentioned in step C refers to processing via a focused laser beam (32) based on a level which is the bottom surface of the groove (11) generated in the prior processing.

4. The method of making patterns for a decorative piece according to claim 1, wherein proceeding with plastic injection and forming tiny pins on the plastic material, each tiny pin has a tip diameter of 0.06˜0.08 mm, a bottom diameter of 0.38˜0.6 mm, and a height of 0.4˜1 mm.

5. The method of making patterns for a decorative piece according to claim 1, wherein the repeatedly and radiately grooving level by level to form a conical groove mentioned in step C refers to proceeding to cut with the laser beam radiated through the reflection of the adjusted prism set, while keeping the height of the laser head unchanged, such that the laser beam will expand and generate a processing laser beam (35), which has a radiating diameter lager than that of the prior processing laser beam (34) used in the prior step.

6. The method of making patterns for a decorative piece according to claim 5, wherein the repeatedly and radiately grooving level by level to form a conical groove mentioned in step C refers to processing via an expanded laser beam (35) based on a level which is the bottom surface of the groove (15) generated in the prior processing.

7. A method of making patterns for a decorative piece, including the following steps:
placing a metal mold substrate under a laser cutting device;
providing a prism set under the laser head which keeps a certain distance away from the mold substrate, such that the laser beam can be utilized in processing through the refraction of the prisms, thereby the processing laser beam can proceed with cutting and forming a groove on the mold substrate;
retaining the height of the laser head unchanged and cutting via a leaser beam having the same diameter to that of the prior laser beam, lastingly grooving on the same position level by level to form a conical groove and complete a mold groove;
moving the laser head (including the prism set) a distance laterally after the first mold groove is completed, and then repeatedly processing steps B to C to accomplish the second mold groove, thereby accomplishing pluralities of mold grooves averagely distributed on a surface of the mold substrate; and
proceeding with plastic injection and forming tiny pins on the plastic material.

8. The method of making patterns for a decorative piece according to claim 7, wherein the lastingly grooving level by level to form a mold groove (14) mentioned in step C refers to forming and expanding an inclined plane around the groove.
